(19) United States
(12) Patent Application Publication
(10) Pub. No.: US 2025/0274429 A1
(43) Pub. Date: Aug. 28, 2025

(54) ENUMERATIVE ADDRESS ASSIGNMENT IN A COMMUNICATION NETWORK

(71) Applicant: WAGO Verwaltungsgesellschaft mbH, Minden (DE)

(72) Inventor: Daniel JEROLM, Bad Essen (DE)

(73) Assignee: WAGO Verwaltungsgesellschaft mbH, Minden (DE)

(21) Appl. No.: 19/065,710

(22) Filed: Feb. 27, 2025

(30) Foreign Application Priority Data
Feb. 27, 2024 (DE) 10 2024 105 544.8

(51) Int. Cl. H04L 61/50; H04L 12/18; H04L 45/745

(52) U.S. Cl. CPC H04L 61/50; H04L 12/18; H04L 45/745

(57) ABSTRACT

A method for enumerative address allocation in a communication network is provided. The communication network may comprise a plurality of communication participants and at least one address providing communication participant. The communication network may be free of meshes. The method may comprise assigning participant-specific addresses to a first group of communication participants which are connected in series. The participant-specific addresses may be defined based on an address enumeration rule, which may depend on the order of the communication participants of the first group. The method may further comprise generating at least one routing table. The routing table may comprise a proper subset of the participant-specific addresses. The routing table may comprise the address enumeration rule for these addresses. Based on the routing table, a message from the address providing communication participant can be routed to any communication participant in the first group.

This nonprovisional application claims priority under 35 U.S.C. § 119 (a) to German Patent Application No. 10 2024 105 544.8, which was filed in Germany on Feb. 27, 2024, and which is herein incorporated by reference.

### BACKGROUND OF THE INVENTION

### Field of the Invention

The present invention relates generally to the technical field of communications technology, in particular to assigning addresses to communication participants in a communication network. The communication participants may, in particular, be electronic components, for example field devices and/or automation devices and/or building technology devices.

### Description of the Background Art

Today's technological landscape is subject to an ever-increasing degree of interconnection between a wide variety of devices and components. This is particularly the case in highly complex environments, such as infrastructure utilities, factories, buildings, etc. In such environments, a large number of electronic components is used. For example, field devices, automation devices or building technology devices. In order to efficiently manage and maintain these electronic components, it is typically necessary to configure them with respect to their software. Data exchange between the electronic components or with a server is also often desired, for example to exchange measured values and/or status information, and/or to transmit instructions for carrying out certain operations. In this respect, electronic components are communication participants in a communication network.

A prerequisite for communication, as described above, is addressing of the communication participants, i.e., the assignment and/or knowledge of addresses in order to exchange data with the respective communication participants.

The problem can be easily explained based on the example of building technology devices. Building technology devices are technical components inside and outside of buildings that serve the use of said buildings. For example, building technology devices include sun protection systems, lighting systems, fire alarm systems, burglar alarm systems, photovoltaic systems, or access control systems. Such devices should be easy to integrate into a building's communication network and be controllable, for example, by a control unit. Conversely, the devices should report their status and/or other data back to the control unit or carry out a data exchange between the devices. For each of the communication operations mentioned, the communication participants need addresses.

In the conventional art, there are various solutions for addressing, for example based on factory-defined unique IDs or serial numbers, from which a unique address can be derived with which a respective communication participant can be addressed. Other solutions involve assigning addresses randomly. All available solutions have disadvantages, especially with regard to the complexity of the addresses and the resulting complex routing tables.

There is, however, a need to provide an improved address allocation procedure compared to the state of the art.

### SUMMARY OF THE INVENTION

It is therefore an object of the invention to provide a method which overcomes the above-mentioned disadvantages of existing solutions.

According to a first aspect of the present invention, a method for enumerative address allocation in a communication network is provided. The communication network may comprise a plurality of communication participants and at least one address providing communication participant. The communication network may be free of meshes. The method may comprise assigning participant-specific addresses to a first group of communication participants which are connected in series. The participant-specific addresses may be defined based on an address enumeration rule, which may depend on the order of the communication participants of the first group. The method may further comprise generating at least one routing table. The routing table may comprise a proper subset of the participant-specific addresses. The routing table may comprise the address enumeration rule for these addresses. Based on the routing table, a message from the address providing communication participant can be routed to any communication participant in the first group.

The term “enumerative address assignment” may be understood as referring to a method in which addresses are assigned sequentially and based on predefined rules. This type of address assignment allows predictions to be made about subsequent addresses and might enable more efficient management of network resources.

A communication network may be viewed as an arrangement of units that are capable of communicating with each other unidirectionally or bidirectionally. It enables the exchange of information between these units which may be referred to as communication participants. For example, a local area network (LAN) in an office or a wired building network with a master-slave architecture may be considered a communication network.

A communication participant in the sense of the present invention refers to any component that is capable of electronically transmitting and/or receiving data, i.e. communicating. Communication participants may, in particular, be electronic components. An electronic component may, in particular, be a field device and/or an automation device and/or a building technology device.

For the purposes of the present invention, a field device can be any type of device that can be used in industrial applications to perform measurements and/or operations. Examples of this may be electrical switches, bus systems, electrical measuring devices, and/or the like.

The term “automation device” refers to devices that may automatically control, regulate, and/or monitor processes without, or substantially without, human intervention. They may be part of industrial control and regulation systems and may include, for example, PLCs, robot systems, or production control systems.

For the purposes of the present invention, the term “building technology device” can mean all permanently installed and mobile technical systems inside and outside a building that serve the use of said buildings. Examples of building technology devices include sun protection systems, air conditioning systems, heating systems, lighting systems, fire alarm systems, burglar alarm systems, photovoltaic systems, or access control systems.

Address assignment is the process by which unique identifiers (addresses) are assigned to the communication participants within a communication network. These addresses enable communication participants to be uniquely identified and thus to establish specific communication connections. Examples include the assignment of participant addresses, IP addresses, or proprietary addresses in a communication network.

A participant-specific address is a unique address that is specifically assigned to a particular communication participant within the communication network. For example, a participant-specific address may be assigned to a specific communication participant in the communication network.

An address providing communication participant is a communication participant that can assign participant-specific addresses within the communication network. This may, for example, be a server that assigns IP addresses in a network, or a control device that assigns participant addresses.

In the context of the present invention, the “routing table” may refer to a data table that is used to determine via which path data packets should be routed to their destination. The routing table may contain information such as addresses and routing rules and therefore be essential for efficient data transmission in the network.

The technical advantages of this method include reducing the complexity of the routing table, as addresses of communication participants can be derived based on the address enumeration rule and do not have to be explicitly included in the routing table. Routing thus becomes much more resource-efficient and simple. This provides an opportunity for scalable and dynamic address assignment, which enables the integration of new network devices without cumbersome manual configuration. By using an address enumeration rule and a routing table, the address assignment may be automated and maintenance effort minimized. In addition, the risk of errors in manual address assignment can be reduced. By using a proper subset of addresses in the routing table, the network structure becomes more transparent and easier to maintain and diagnose, contributing to increased reliability of the entire system.

After the addresses have been assigned, configurations or queries of measurement and/or state data may be carried out, wherein individual communication participants can be addressed specifically using unicast addressing. The term configuration may, in particular, include the setting of an electronic component, which can be a communication participant. The aim of a configuration may be for the electronic component to perform functions and/or to achieve certain behaviors and/or to have certain properties. Configuration processes may, in particular, be the programming and/or setting of parameters.

The steps of assigning participant-specific addresses and generating a routing table may be carried out for a second group of communication participants, and preferably these steps may be carried out for a plurality of groups. In particular, this may continue until all communication participants in the groups of the communication network have participant-specific addresses that are defined based on an address enumeration rule and depend on the order of the respective communication participants in the respective group.

The term “second group” and the idea of further “groups” of communication participants can be separate subsets or segments of communication participants within the network. Each of these groups can be treated according to the same principle of enumerative address assignment, which enables clear and uniform structuring.

The technical advantages of this extension of the method include high flexibility and scalability of the communication network. As a result of the extension to multiple groups, large and complex networks can be addressed and managed efficiently. The rule-based assignment of addresses in conjunction with effective routing provides the basis for future-proof network management by simplifying the integration of new participants and minimizing the susceptibility to errors. In addition, the ability to extend the system without major hassle contributes to long-term cost efficiency and minimizes downtime, as changes to the network structure can be easily made when needed.

An address reserve may be provided in the routing table at least for the first group of communication participants. This may include a predetermined number of reserve addresses that are not initially assigned to any of the communication participants in the first group.

The term “address reserve” can be understood as a buffer of additional addresses provided in the routing table for future extensions or in the event of the addition of additional communication participants to the existing group. These reserve addresses will initially remain unused until there is a need to extend the group.

The “predetermined number” of reserve addresses can be interpreted as a fixed quantity that is carefully selected to meet future needs without wasting unused address space.

The technical advantages of providing an address reserve include the flexible scalability of the network, which allows the system to be easily adapted to growing requirements and the integration of new devices. In addition, the integration of an address reserve reduces the risk of address conflicts and the need to re-address the entire network or perform extensive network reconfigurations, increasing operational efficiency and network stability.

The routing table may contain information that marks the reserve addresses as inactive. As part of an extension of the first group of the communication network, these reserve addresses may be assigned to one or more new communication participants. Furthermore, the information that identifies the addresses as inactive may be removed from the routing table as soon as the addresses are activated.

The term “inactive” with respect to the reserve addresses can be understood in the context of the present invention as a state in which the addresses exist but are not currently assigned to an active participant and thus do not participate in communication processes.

This ability to mark reserve addresses as inactive and to unmark them when they are needed offers technical advantages such as increasing the flexibility and efficiency of the addressing process. It also provides a clear distinction between currently used and free addresses, which simplifies network management. The ability to edit information on reserve addresses when extending the network participants enables agile and dynamic network management, allowing rapid response to changes without the need for a complete reprocessing of the addressing scheme. This contributes to increased operational reliability and reduced downtime during maintenance or network extension.

The address enumeration rule may allow, within the described method, a prediction of the next address based on an already assigned previous address, wherein this may be done, for example, by address definitions in ascending or descending order, and/or by means of a count. Preferably, the address enumeration rule is based on integers or on an enumeration order that can be mapped to integers, in particular an ascending or descending enumeration order.

As described above, in the context of the present invention, the term “address enumeration rule” may be understood as a fixed rule or procedure according to which addresses are assigned to network participants in a predictable manner. In particular, this rule makes it possible to determine the immediately following or preceding address in the network from a known address.

The use of an “ascending or descending order” in the address enumeration rule enables a logical and ordered addressing that corresponds to the physical structure or logical structure of the network. In this way, the network system can be managed and navigated intuitively.

The technical advantages of such an address enumeration rule include simplified network planning and monitoring, since addresses can be easily identified and assigned based on their position in the sequence. This may be particularly useful for troubleshooting and network maintenance, as the physical or logical location of a device can be quickly derived from its address. In addition, this methodology helps automate the address assignment process and reduces the risk of address conflicts because the unique sequence reduces the likelihood of two devices having the same address. The predictability of address assignment contributes to increased network efficiency and reliability.

It may be that, within the framework of the method, based on the proper subset of participant-specific addresses and on the address enumeration rule, any other participant-specific address that is not contained in the proper subset can be derived.

In the context of the present invention, the term “proper subset” can be understood as a subset of participant-specific addresses from a total of participant-specific addresses of a specific group of communication participants and/or the totality of addresses in the network. The efficiency of network management is increased because not all addresses must be explicitly stored or managed in the routing table. This saves storage space and reduces administration effort. On the other hand, the ability to derive addresses makes network planning and scaling easier.

The communication network may have a master-slave architecture and the at least one address providing communication participant may be a master participant.

In the context of the present invention, the term “master-slave architecture” can be understood as a network topology concept in which a master participant (master) has control over one or more other participants (slaves). This typically includes communication control and monitoring, with the master coordinating network activities and resource management.

The term “master participant” or simply “master” can be understood as a superordinate device or component in the communication network that is responsible for assigning addresses to other network participants (the slaves). The master participant thus coordinates the address allocation process and maintains an overview of the network topology.

The technical advantages of this arrangement can be seen particularly in relation to centralized control and monitoring of the entire address allocation process. Because the master assigns and manages the addresses, conflicts or redundant address assignments can be avoided and consistency in network addressing can be ensured. It also makes network setup and maintenance easier because the master acts as the primary point of contact for configuration and troubleshooting. This clear hierarchy and distribution of roles in the network structure leads to simplified and more efficient data transmission and processing. In addition, the master-slave architecture can reduce the load on the individual slave participants.

Communication connections between the communication participants may be separable, wherein the step of assigning may comprise: generating, based on the separable communication connections, a state of the communication network in which the address providing communication participant can reach exactly one address seeking communication participant to which a participant-specific address is to be assigned via a broadcast message; and sending, by the address providing communication participant, a broadcast message comprising a participant-specific address that is to be assigned to the address seeking communication participant in order to enable communication by means of unicast addressing with the address seeking communication participant.

A communication connection is the combination of the physical and logical connection that enables communication between communication participants in a communication network. An example of this could be a wired communication line between communication participants.

A separable communication connection is a type of communication connection that can be opened or closed as needed. This may be achieved through physical means, such as switches, or through software-controlled methods, such as disabling a specific interface.

In the context of the present invention, an address seeking communication participant is a communication participant that does not have a participant-specific address and may receive a message from the address providing communication participant. For example, if the communication connections between the communication participants are to be separable, the communication connections can be separated and only one communication connection can be established, which exists between the address providing communication participant and a communication participant without a participant-specific address, which in this respect is the address seeking communication participant. In complex, for example non-star-shaped communication networks, the broadcast message of the address providing communication participant may be received by a large number of communication participants that are intermediate the address providing communication participant and the exactly one address seeking communication participant, wherein the broadcast message is ignored by the intermediate communication participants because they already have a participant-specific address.

A broadcast message is a message that is sent to all communication participants or a group of communication participants in a network. For example, such a message could be sent by a server or by a control unit.

Unicast addressing is a type of message transmission in a communication network in which a message is addressed directly from the sender to a specific recipient. In particular, the message may comprise the address of the recipient, i.e., of the receiving communication participant.

The present invention is advantageous in terms of efficiency and flexibility in address allocation within communication networks. The method according to the invention significantly optimizes address allocation in a communication network. The heart of the invention is the generation of a special state of the communication network in which exactly one address seeking communication participant can be reached by a broadcast message. This simplifies and accelerates the address assignment procedure because the address providing communication participant can operate with broadcast messages and yet only a selected, address seeking unit is addressed. This minimizes the risk of address conflicts or duplications, which could disrupt communication in a network. Once the address has been assigned, the procedure enables the use of unicast addressing. This enables direct and efficient communication in the communication network, especially with very low latency.

The method may further comprise receiving, by the address seeking communication participant, the broadcast message. Furthermore, the method may comprise adopting, by the address seeking communication participant, the participant-specific address contained in the received broadcast message to enable communication with the address seeking communication participant through unicast addressing. The broadcast message preferably comprises a command to the following effect: adopt the address contained in the broadcast message as the participant-specific address if no participant-specific address exists yet.

The separability of the communication connections between the communication participants may be realized by means of electronic switches, which may be opened and closed, in particular via messages from the address providing communication participant, in order to separate or establish respective communication connections. In particular, each communication connection may be separable, wherein preferably each communication participant has at least one electronic switch.

Thus, the concept of separability of communication relationships may be realized in a simple manner by implementing electronic switches. The use of electronic switches contributes to the efficiency and speed of the address assigment, as they can react immediately to the signals or messages from the address provider.

The step of generating the state of the communication network may comprise sending, by the address providing communication participant, at least one preparatory broadcast message for effecting at least one operation in communication participants receiving the at least one preparatory broadcast message. Preferably, the execution of an operation by communication participants is linked to a condition, wherein the condition may comprise that the respective communication participant does not have a participant-specific address.

Preparatory messages enable network actors to perform specific actions that assist in bringing the network into the optimal state for address assignment. This improves the preparation of the network for address assignment and supports an efficient and orderly implementation of the address allocation process.

Furthermore, the at least one preparatory broadcast message may comprise at least one of the following commands: establish all possible communication connections, in particular by closing electrical switches; and/or if no participant-specific address is available, disconnect all possible communication connections, in particular by opening electrical switches; and/or if a participant-specific address is available, remove the participant-specific address; and/or adopt the address contained in the broadcast message as the participant-specific address if no participant-specific address is available yet.

The diverse possibilities of the preparatory broadcast messages are optimally utilized and expanded with these command options. The first option, “establish all possible communication connections, in particular by closing electrical switches,” allows the network to be brought into a state in which all participants are connected to each other. This can be useful in situations where broad communication or command dissemination to all participants is required. In particular, this may ensure that the communication network does not have any disconnected branches that cannot be reached during the further course of the process and hence cause errors. The message may be sent several times in succession to reduce the probability of packet loss or other errors occurring.

The second option, “disconnect all possible communication connections, in particular by opening electrical switches, if no participant-specific address is available yet”, enables targeted and efficient address allocation by isolating address seeking participants from the others.

The third option, “if a participant-specific address is available, remove the participant-specific address”, provides an additional layer of control in the address assignment. This allows the system to remove the originally assigned address and assign a new, more appropriate address if necessary.

The fourth option, “adopt the address contained in the broadcast message as participant-specific address if no participant-specific address is available yet”, offers an optimal solution for the address assignment itself. This means that if a participant does not yet have an address, it can adopt the address specified in the message and consequently become an addressed participant.

Overall, the use of a preparatory message, as described above, offers a high degree of flexibility and precision in carrying out the method according to the present invention.

The step of generating the state of the communication network may comprise: sending, preferably sending multiple times, by the address providing communication participant, a preparatory broadcast message to effect the following operation in communication participants which receive the preparatory broadcast message: establish all possible communication connections, preferably by closing electrical switches; sending, by the address providing communication participant, a preparatory broadcast message to effect the following operation at communication participants that receive the preparatory broadcast message: if a participant-specific address is available, remove the participant-specific address; disconnecting all communication connections at the address providing communication participant, preferably by opening electrical switches; establishing exactly one communication connection at the address providing communication participant, preferably by closing an electrical switch, or establishing exactly one communication connection at a communication participant that is not the address providing communication participant by sending a preparatory unicast message to effect the following operation at the communication participant that receives the preparatory unicast message: establish exactly one communication connection, preferably by closing electrical switches; and/or sending, by the address providing communication participant, a preparatory broadcast message to effect the following operation in communication participants that receive the preparatory broadcast message: disconnecting, if no participant-specific address is yet available, all possible communication connections, preferably by opening electrical switches.

According to a second aspect of the present invention, an address providing communication participant is provided, preferably a master participant of a communication network with a master-slave architecture. The address providing communication participant may be configured to carry out respective steps according to the first aspect of the present invention.

According to a third aspect of the present invention, a communication participant, preferably a slave participant of a communication network with a master-slave architecture, may be provided which is configured to adopt a participant-specific address by a method according to the first aspect of the present invention.

According to a fourth aspect of the present invention, a communication network is provided, comprising at least one address providing communication participant, preferably according to the second aspect of the present invention, and at least one communication participant, preferably according to the third aspect of the present invention, wherein the communication network is configured to carry out a method according to the first aspect of the present invention.

In the communication network, preferably all communication participants may be configured according to the third aspect of the present invention to support the following commands, which may be received through broadcast messages: establish all possible communication connections, in particular by closing electrical switches; and/or if no participant-specific address is available, disconnect all possible communication connections, in particular by opening electrical switches; and/or if a participant-specific address is available, remove the participant-specific address; and/or use the address contained in the broadcast message as the participant-specific address if no participant-specific address is available yet.

In the communication network, preferably all communication participants, in particular according to the third aspect of the present invention, may be configured to support the following commands, which may be received by means of unicast addressing: establish a specific communication connection, in particular by closing at least one electrical switch; and/or share existing properties, in particular the number of existing communication connections to other communication participants.

According to a fifth aspect of the present invention, a computer program or a computer-readable medium is provided, comprising instructions which cause a computer, in particular a device according to the second and/or fourth aspect of the present invention, to carry out a method according to the first aspect of the present invention.

All features, technical details and advantages described with respect to one of the aspects of the present invention also apply mutatis mutandis to each of the other aspects of the present invention and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a first schematic depiction of an example of the present invention.

FIG. 2 shows a second schematic depiction of an example of the present invention.

FIG. 3 shows a third schematic depiction of an example of the present invention.

FIG. 4 shows a first exemplary state of a communication network according to an example of the present invention.

FIG. 5 shows a second exemplary state of a communication network according to an example of the present invention.

FIG. 6 shows a third exemplary state of a communication network according to an example of the present invention.

FIG. 7 shows a first exemplary state of switch positions of a communication network according to an example of the present invention.

FIG. 8 shows a second exemplary state of switch positions of a communication network according to an example of the present invention.

FIG. 9 shows a first exemplary flowchart of an example of the present invention.

FIG. 10 shows a second exemplary flowchart of an example of the present invention.

FIG. 11a shows a first portion of an exemplary flowchart of an example of the present invention.

FIG. 11 shows a second portion of an exemplary flowchart of an example of the present invention.

### DETAILED DESCRIPTION

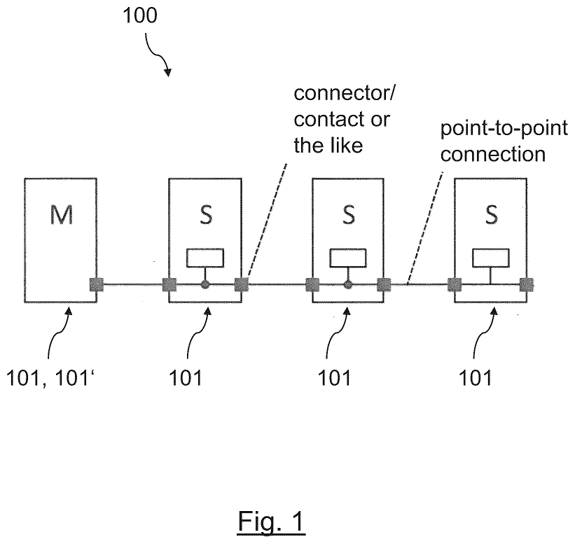

FIG. 1 shows an example of a simple communication network 100 according to embodiments of the present invention. The communication network 100 comprises several communication participants 101, wherein one communication participant 101 is an address providing communication participant 101′. The communication network 100 has a master-slave architecture, which is indicated by the letters M and S in the figure. The address providing communication participant 101′ is a master participant M. The other communication participants 101 are slave participants S. The communication participants 101 are connected by communication connections. The communication connections may, in particular, be wired communication connections which are based, for example, on connectors and/or contacts and/or I/O interfaces. From a physical perspective, these may be point-to-point communication connections between the communication participants 101. In FIG. 1, there is a continuous communication line to which the communication participants 101 are connected in parallel, thus forming an internal parallel connection of slave participants S.

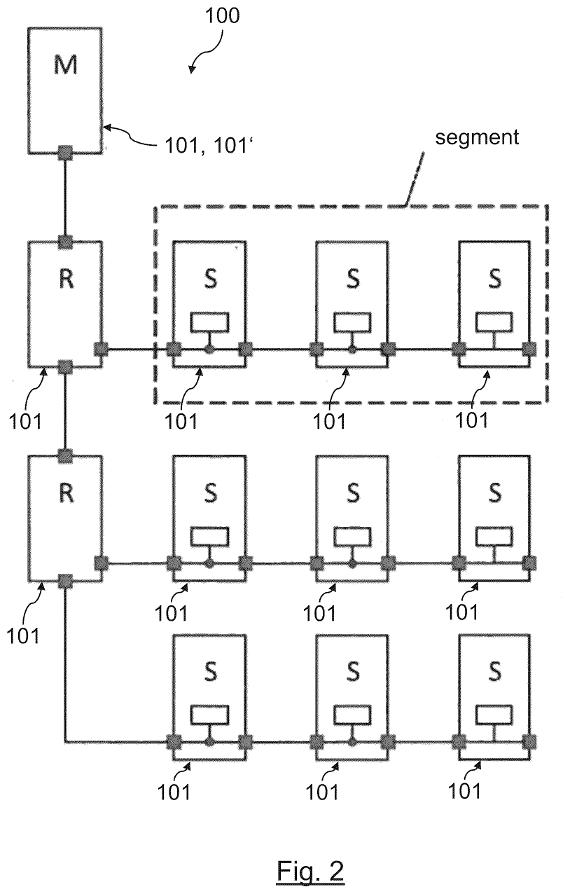

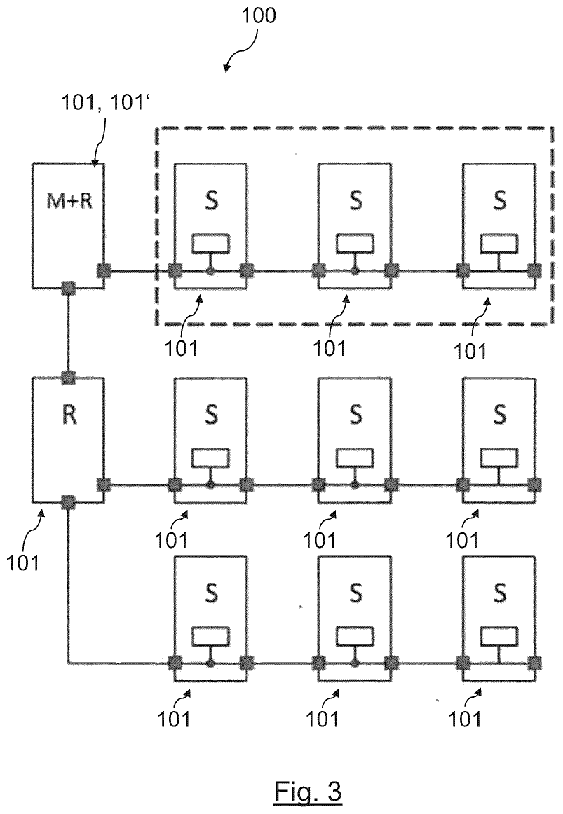

FIG. 2 shows another exemplary embodiment of a communication network 100 according to embodiments of the present invention. The communication network 100 has a tree structure which is formed by an address-transmitting communication participant 101′ which is configured to be a master participant M and by eleven communication participants 101 which are configured to be slave participants S, wherein two of the communication participants 101 which are configured to be slave participants S comprise a switch functionality, as indicated in FIG. 3 by the letter R. The communication participants 101 which are configured to be slave participants S and comprise a switch functionality form, due to their switch functionality, the nodes for the tree structure, at which respective segments of the communication network 100 are arranged. In other words, groups of communication participants 101 which are configured to be slave participants S may be connected in parallel in separate segments.

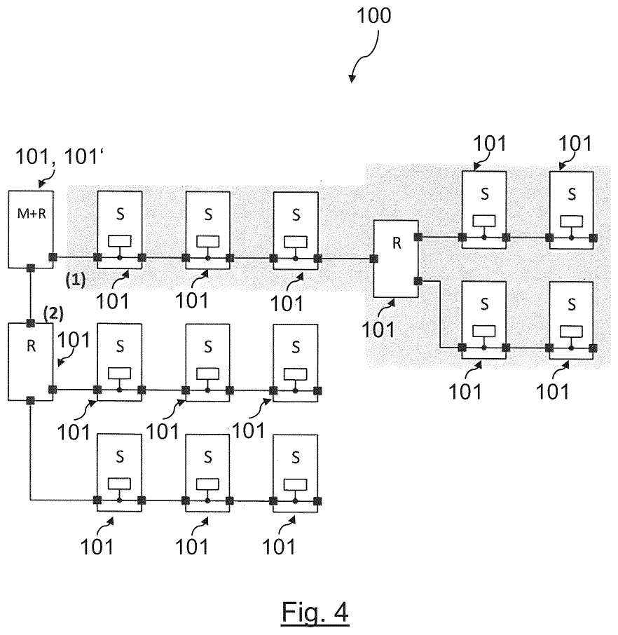

FIG. 3 shows another exemplary embodiment of a communication network 100 according to embodiments of the present invention. FIG. 4 differs from FIG. 3 in that the address providing communication participant 101′, which is configured to be the master participant M, has a switch functionality and thus the communication network is even simpler in structure as it, to put it differently, comprises one fewer communication participant.

FIG. 4 schematically illustrates an exemplary embodiment of a communication network 100 with several groups of communication participants 101. The communication participants 101 which are shown on a gray background can be viewed as a first group of communication participants 100. This first group may further include sub-groups.

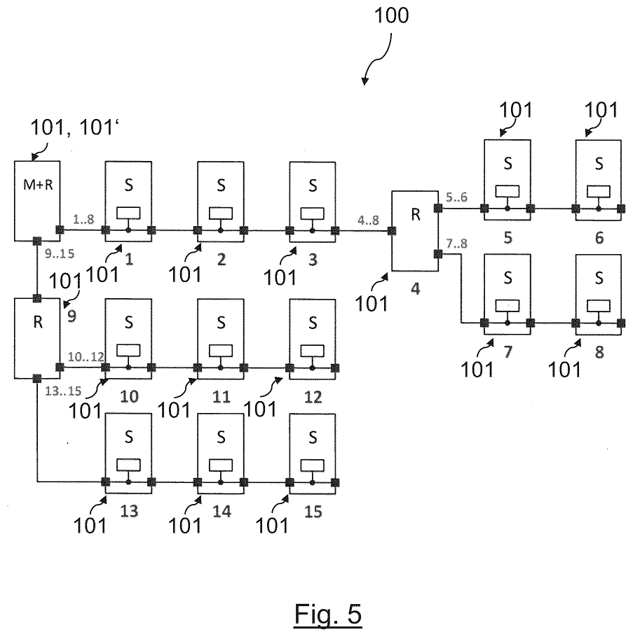

FIG. 5 shows a state of a communication network 100 in which a method for enumerative address assignment has been carried out. The communication network 100 comprises a plurality of communication participants 101. Included is an address providing communication participant 101′, which is identified by “M+R” (master communication participant with switch functionality). The communication network 100 is be free of meshes. Steps of assigning participant-specific addresses, by the address-providing communication participant 101′, to groups of communication participants 101 connected in series have been carried out. The respective participant-specific addresses were defined based on an address enumeration rule depending on the order of the communication participants 101 of the respective group. This can be seen from the numbers illustrated on the connecting lines that represent the communication lines. These are numbered in ascending order and form, in an example, a part of the participant-specific address of the respective communication participant 101. Furthermore, a routing table has been generated which contains a proper subset of the participant-specific addresses of the respective group and the address enumeration rule for the participant-specific addresses of the respective group, so that, based on the routing table, a message from the address providing communication participant 101′ can be routed to any communication participant of the respective group.

Based on the address enumeration rule, addresses of communication participants 101 can be derived and do not have to be explicitly included in the routing table, which, for example, may be stored in a slave with switch functionality (communication participant with letter “R” in FIG. 5) or in a master with switch functionality (communication participant with letters “M+R” in FIG. 5). Routing thus becomes much more resource-efficient and simple. This provides an opportunity for scalable and dynamic address assignment, which enables the integration of new network devices without cumbersome manual configuration. By using an address enumeration rule and a routing table, the address assignment may be automated and the maintenance effort may be minimized. In addition, the risk of errors in manual address assignment can be reduced. By using a proper subset of addresses in the routing table, the network structure becomes more transparent and easier to maintain and diagnose, contributing to increased reliability of the entire system.

After the addresses have been assigned, configurations or queries of measurement and/or state data may be carried out, wherein individual communication participants can be addressed specifically using unicast addressing. The term configuration may, in particular, include the setting of an electronic component, which can be a communication participant. The aim of a configuration may be for the electronic component to perform functions and/or to achieve certain behaviors and/or to have certain properties. Configuration processes may, in particular, be the programming and/or setting of parameters.

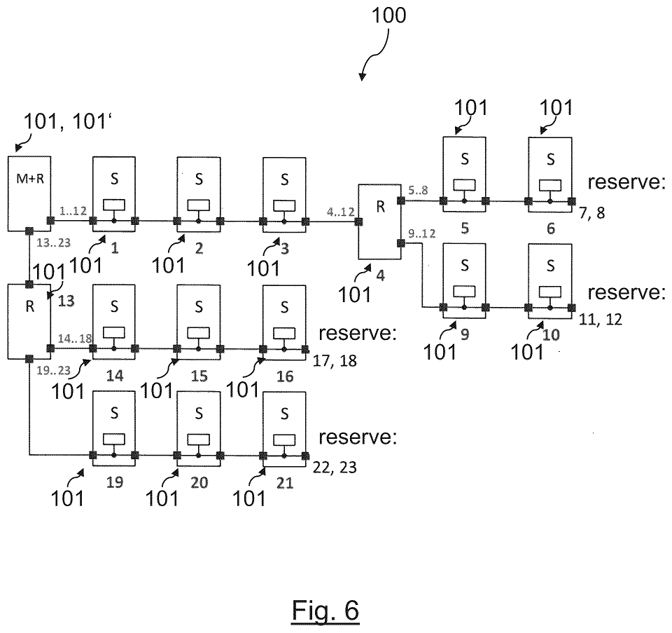

FIG. 6 is based on FIG. 5, wherein there is also provided for reserve addresses. The number of reserve addresses for each group may be predefined. Respective routing tables may comprise information which identifies the reserve addresses as inactive, wherein the reserve addresses can be assigned to one or more new communication participants in the course of an extension of the first group and the respective information in the routing table can be removed.

Reserve addresses advantageously enable flexible scalability of the network, allowing to easily adapt the system to growing requirements and the integration of new devices. In addition, the risk of address conflicts and the need to re-address the entire network or perform extensive network reconfiguration is reduced. The ability to mark reserve addresses as inactive provides a clear distinction between currently used and free addresses, thus simplifying network management.

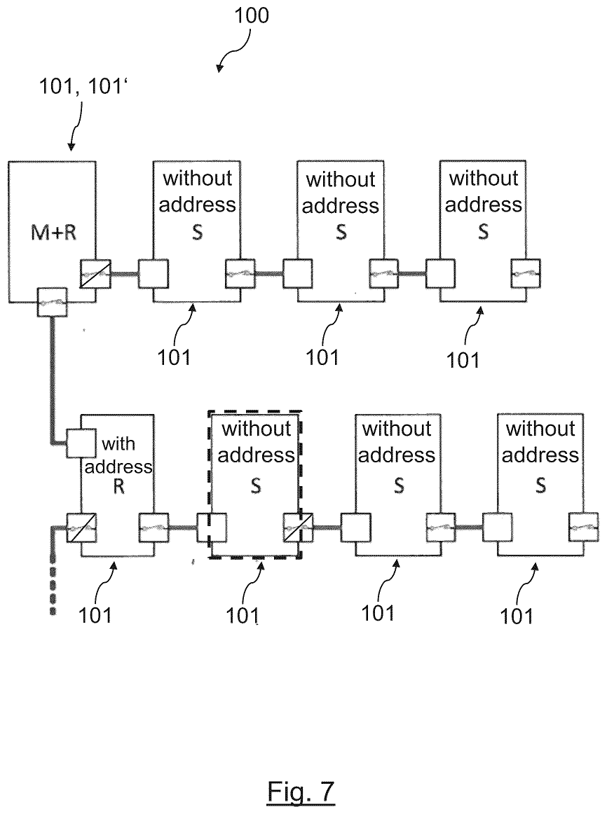

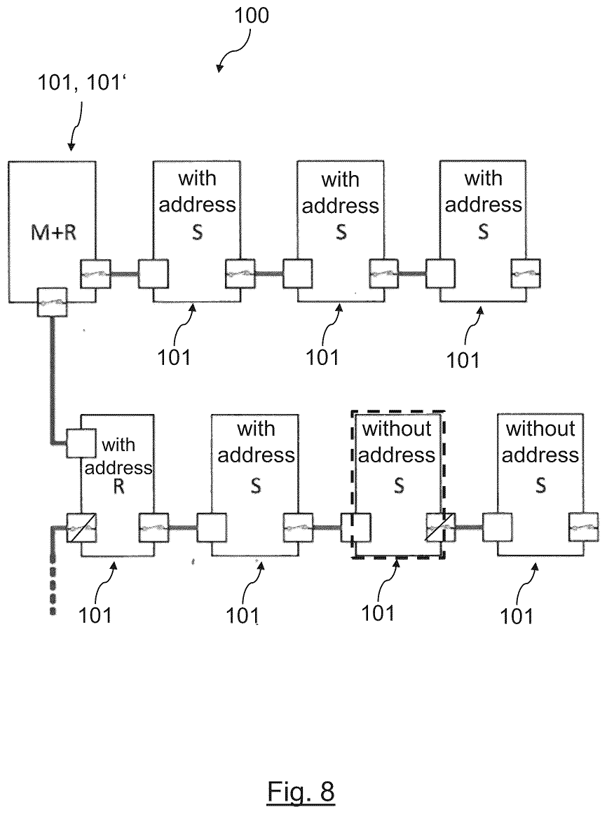

FIGS. 7 and 8 each show exemplary states of a communication network according to embodiments of the present invention, in which exactly one address seeking communication participant 101 without a participant-specific address can be reached by means of a broadcast message. This state is realized by means of electronic switches that can be opened or closed.

In the example of FIG. 7, all communication participants 101 which are configured to be slave participants S have no participant-specific address. The aim is to provide a specific address seeking communication participant 101, which is surrounded by dashed lines, with a participant-specific address. For this purpose, a state was created, as shown in FIG. 7, in which, based on the separable communication connections, the address providing communication participant 101′ can reach exactly the desired address seeking communication participant 101 via a broadcast message as the only communication participant 101 that does not have a participant-specific address, and can instruct the address seeking communication participant 101 to adopt the participant-specific address. Disconnected communication connections and the respective opened electronic switches are shown crossed out.

In the example of FIG. 8, some communication participants 101 already have a participant-specific communication address. Here, too, a state is shown in which exactly one desired address seeking communication participant 101 can be provided with a participant-specific address by means of a broadcast message. This one is again surrounded by a dashed line.

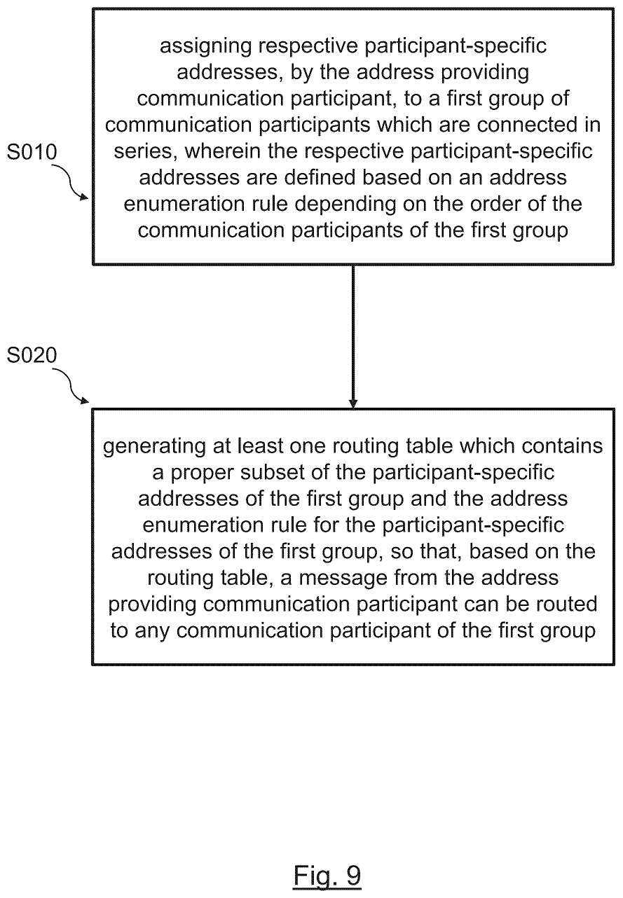

FIG. 9 shows a flowchart with steps according to embodiments of the present invention. Step S010 comprises assigning respective participant-specific addresses, by the address providing communication participant 101′, to a first group of communication participants 101 which are connected in series, wherein the respective participant-specific addresses are defined based on an address enumeration rule depending on the order of the communication participants 101 of the first group. Step S020 comprises generating at least one routing table which contains a proper subset of the participant-specific addresses of the first group and the address enumeration rule for the participant-specific addresses of the first group, so that, based on the routing table, a message from the address providing communication participant 101′ can be routed to any communication participant 101 of the first group.

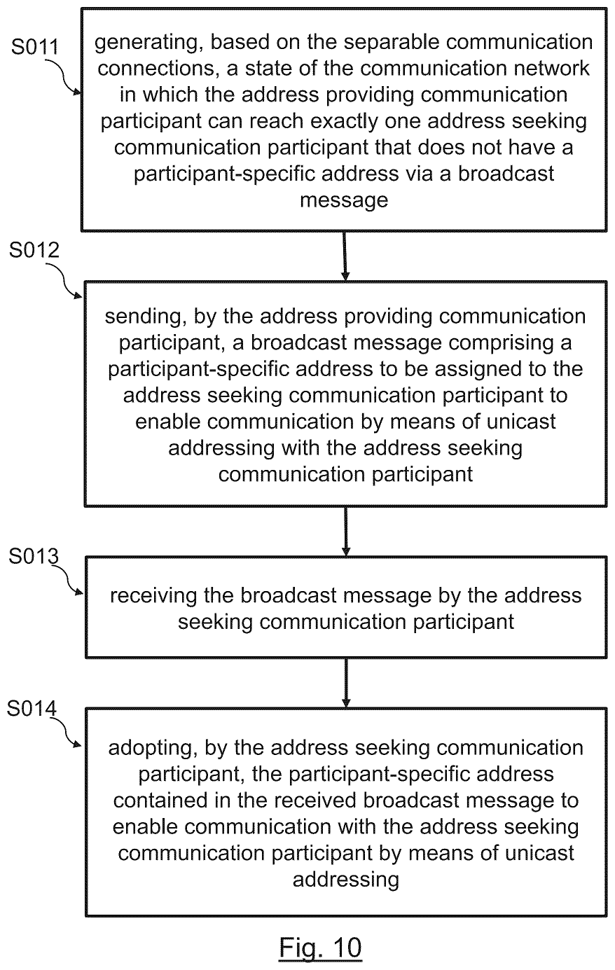

FIG. 10 shows a further flow chart with various steps according to embodiments of the present invention, which can be understood as sub-steps to the above-mentioned step S010. Step S011 comprises generating, based on the separable communication connections, a state of the communication network in which the address providing communication participant 101′ can reach exactly one address seeking communication participant 101 that does not have a participant-specific address via a broadcast message. Step S012 comprises sending, by the address providing communication participant 101′, a broadcast message comprising a participant-specific address to be assigned to the address seeking communication participant 101 to enable communication by means of unicast addressing with the address seeking communication participant 101. Step S013 comprises receiving the broadcast message by the address seeking communication participant 101. Step S014 comprises adopting, by the address seeking communication participant 101, the participant-specific address contained in the received broadcast message to enable communication with the address seeking communication participant 101 by means of unicast addressing, wherein the broadcast message may comprise a command to the following effect: adopt the address contained in the broadcast message as a participant-specific address if no participant-specific address is yet available.

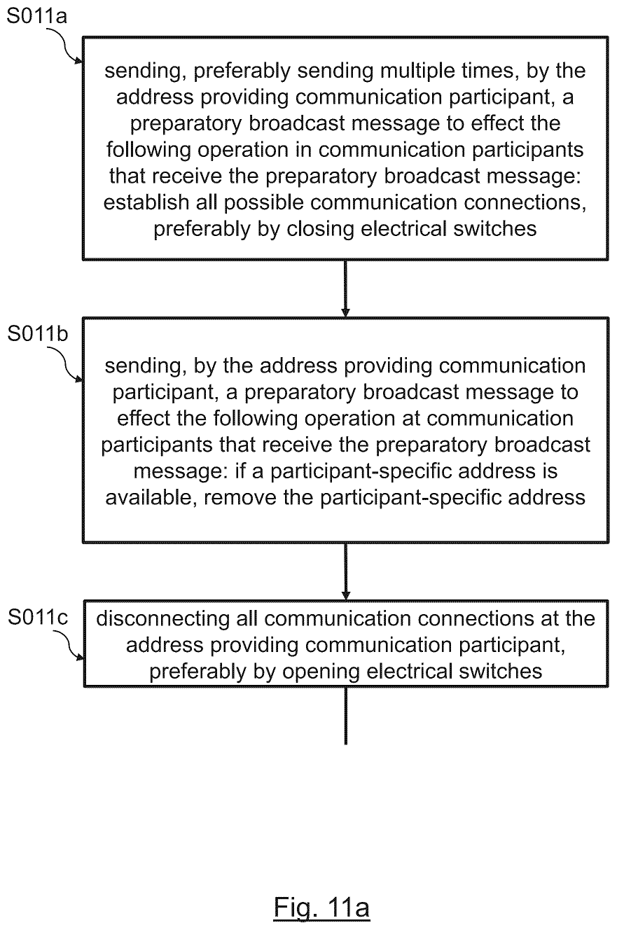

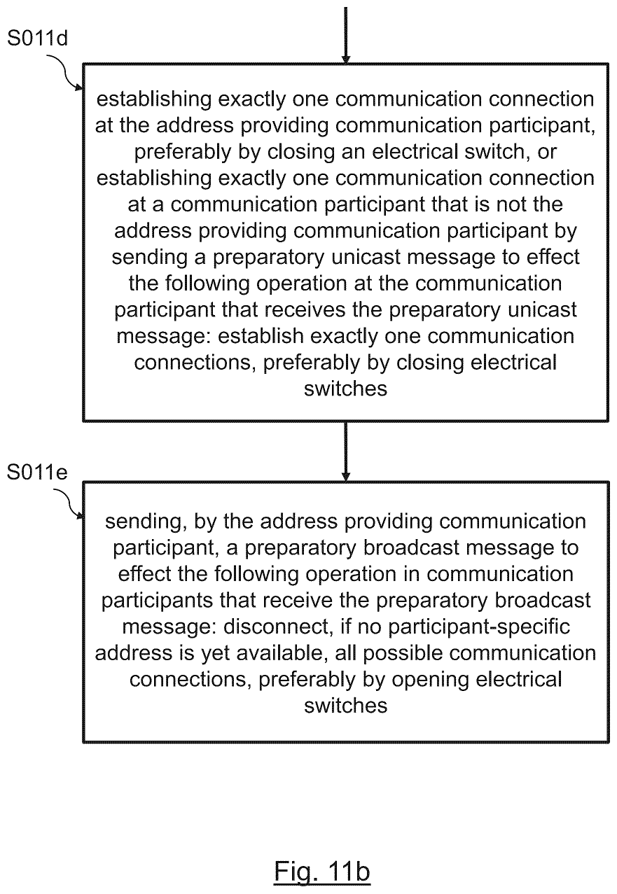

FIGS. 11a and 11b show a two-part exemplary flow chart for carrying out step S011. The flow chart comprises, in step S011a, sending, preferably sending multiple times, by the address providing communication participant 101′, a preparatory broadcast message to effect the following operation in communication participants 101 that receive the preparatory broadcast message: establish all possible communication connections, preferably by closing electrical switches. The flow chart further comprises, in step S011b, sending, by the address providing communication participant 101′, a preparatory broadcast message to effect the following operation at communication participants 101 that receive the preparatory broadcast message: if a participant-specific address is available, remove the participant-specific address. The flow chart further comprises, in step S011c, disconnecting all communication connections at the address providing communication participant, preferably by opening electrical switches. The flow chart further comprises, in step S011d, establishing exactly one communication connection at the address providing communication participant 101′, preferably by closing an electrical switch, or establishing exactly one communication connection at a communication participant 101 that is not the address providing communication participant 101′ by sending a preparatory unicast message to effect the following operation at the communication participant 101 that receives the preparatory unicast message: establish exactly one communication connection, preferably by closing electrical switches. The flow chart further comprises, in step S011e, sending, by the address providing communication participant, a preparatory broadcast message to effect the following operation in communication participants 101 that receive the preparatory broadcast message: disconnect, if no participant-specific address is yet available, all possible communication connections, preferably by opening electrical switches.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for enumerative address allocation in a communication network, wherein the communication network comprises a plurality of communication participants including at least one address providing communication participant, the communication network being free of meshes, the method comprising:
assigning respective participant-specific addresses, by the address providing communication participant, to a first group of communication participants which are connected in series, the respective participant-specific addresses being defined based on an address enumeration rule depending on the order of the communication participants of the first group; and
generating at least one routing table which contains a proper subset of the participant-specific addresses of the first group and the address enumeration rule for the participant-specific addresses of the first group, so that, based on the routing table, a message from the address providing communication participant is routed to any communication participant of the first group.

2. The method of claim 1, wherein the steps of assigning and generating are carried out for a second group or for a plurality of groups, of communication participants of the communication network until all communication participants in groups of the communication network have participant-specific addresses which are defined based on an address enumeration rule depending on the order of the respective communication participants of the respective group.

3. The method of claim 1, wherein an address reserve is provided in the routing table at least for the first group of communication participants, the address reserve comprising a predetermined number of reserve addresses which are not assigned to any of the communication participants of the first group.

4. The method of claim 3, wherein the routing table comprises information which identifies the reserve addresses as inactive, wherein the reserve addresses is assigned to one or more new communication participants in the course of an extension of the first group and the respective information in the routing table is removed.

5. The method of claim 1, wherein the address enumeration rule allows a prediction of a succeeding address based on a preceding address or by an address definition in ascending or descending order and/or counting, and wherein the address enumeration rule is based on integers and/or on an enumeration order mappable to integers ascending or descending.

6. The method according to claim 1, wherein, based on the proper subset of participant-specific addresses and based on the address enumeration rule, any other participant-specific address not contained in the proper subset is derivable.

7. The method of claim 1, wherein the communication network has a master-slave architecture, and wherein the at least one address providing communication participant is a master participant.

8. The method of claim 1, wherein communication connections between the communication participants are separable, and wherein the step of assigning comprises:
generating, based on the separable communication connections, a state of the communication network in which the address providing communication participant reach exactly one address seeking communication participant to which a participant-specific address is to be assigned, via a broadcast message; and
sending, by the address providing communication participant, a broadcast message comprising a participant-specific address to be assigned to the address seeking communication participant to enable communication via unicast addressing with the address seeking communication participant.

9. The method of claim 8, wherein the step of assigning further comprises:
receiving the broadcast message by the address seeking communication participant; and
adopting, by the address seeking communication participant, the participant-specific address contained in the received broadcast message in order to enable communication via unicast addressing with the address seeking communication participant,
wherein the broadcast message comprises a command to the following effect: adopt the address contained in the broadcast message as a participant-specific address if no participant-specific address is yet available.

10. The method according to claim 8, wherein the separability of the communication connections between the communication participants is realized via electronic switches, which may be opened and closed by messages from the address providing communication participant in order to disconnect or establish respective communication connections, wherein each communication connection is designed to be separable, and wherein each communication participant has at least one electronic switch.

11. The method according to claim 8, wherein the step of generating the state of the communication network comprises:
sending, by the address providing communication participant, at least one preparatory broadcast message for effecting at least one operation in communication participants receiving the at least one preparatory broadcast message,
wherein, the execution of an operation by communication participants is linked to a condition, the condition comprising that the respective communication participant does not have a participant-specific address.

12. The method of claim 11, wherein the at least one preparatory broadcast message comprises at least one of the following commands:
establish all possible communication connections, in particular by closing electrical switches; and/or
if no participant-specific address is available, disconnect all possible communication connections, in particular by opening electrical switches; and/or
if a participant-specific address is available, remove the participant-specific address; and/or
adopt the address contained in the broadcast message as the participant-specific address if no participant-specific address is available yet.

13. The method according to claim 1, wherein the step of generating the state of the communication network comprises:
sending or sending multiple times, by the address providing communication participant, a preparatory broadcast message to effect the following operation in communication participants receiving the preparatory broadcast message: establish all possible communication connections, preferably by closing electrical switches;
sending, by the address providing communication participant, a preparatory broadcast message to effect the following operation at communication participants that receive the preparatory broadcast message: if a participant-specific address is available, remove the participant-specific address;
disconnecting all communication connections at the address providing communication participant by opening electrical switches;
establishing exactly one communication connection at the address providing communication participant by closing an electrical switch or establishing exactly one communication connection at a communication participant that is not the address providing communication participant by sending a preparatory unicast message to effect the following operation at the communication participant that receives the preparatory unicast message: establish exactly one communication connection, preferably by closing electrical switches; and
sending, by the address providing communication participant, a preparatory broadcast message to effect the following operation in communication participants that receive the preparatory broadcast message: disconnect, if no participant-specific address is yet available, all possible communication connections, by opening electrical switches.

14. A communication network comprising at least one address providing communication participant and a plurality of further communication participants, wherein the communication network is configured to carry out the method according to claim 1.

15. The communication network of claim 14, wherein the plurality of further communication participants are configured to support the following commands that are receivable via broadcast messages:
establish all possible communication connections by closing electrical switches; and/or
if no participant-specific address is available, disconnect all possible communication connections by opening electrical switches; and/or
if a participant-specific address is available, remove the participant-specific address; and/or
use the address contained in the broadcast message as the participant-specific address if no participant-specific address is available yet.

16. A computer program or a computer-readable medium comprising instructions which cause a computer or a communication participant of a communication network to carry out the method according to claim 1.
